(19) United States
(12) Patent Application Publication
(10) Pub. No.: US 2010/0293805 A1
(43) Pub. Date: Nov. 25, 2010

(54) NAIL GEL SOLIDIFICATION APPARATUS

(76) Inventor: Pao-Min Chang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/469,114

(22) Filed: May 20, 2009

(51) Int. Cl. F26B 3/28; F26B 3/30; F26B 25/06

(52) U.S. Cl. 34/202; 132/73.5; 392/411; 392/418

(57) ABSTRACT

The present invention discloses a nail gel solidification apparatus including a housing, a control circuit board, a plurality of reflecting lamp holders, a plurality of light emitting diode (LED) elements and a power supply module. By replacing the traditional lamp with the LED elements of the reflecting lamp holders, the invention provides longer using life and lower power consumption and reduces the solidification time for nail gels.

### FIELD OF THE INVENTION

The present invention relates to a nail gel solidification apparatus, in particular to an artificial nail gel solidification apparatus.

### BACKGROUND OF THE INVENTION

With reference to FIG. 1 for a conventional nail gel (or nail polish) solidification apparatus 1, the nail gel solidification apparatus 1 adopts a lamp 2, particularly an ultraviolet (UV) lamp, as a light source for solidifying the nail gel. However, the illumination of the lamp 2 produces a relatively large quantity of heat and causes a rise of resistance in circuits, and thus the life of a control circuit will be shortened after a long time of use. In the lamp 2 as shown in FIG. 2, the light source is scattered in different directions, not only wasting electric power, but also requiring more time for the solidification of the nail gel. The life of the lamp 2 is also shorter, and it is necessary to replace the lamp 2 more frequently, and thus it incurs a higher cost. Furthermore, the nail gel solidification apparatus 1 includes a base 3, so that it is not applicable for the use for hands and feet. If a user puts the feet into the nail gel solidification apparatus 1, the sweat discharged from the feet will remain on the base 2 during the nail gel solidification period, and no one would want to put one's hands into the contaminated nail gel solidification apparatus 1 again for the solidification of nail gel. Regardless of the considerations of hygiene or cost, the conventional nail gel solidification apparatus 1 requires improvements.

Therefore, it is a major subject for the present invention to develop a nail gel solidification apparatus applicable for both hands and feet and achieve the effects of shortening the solidification time and lowering the cost.

### SUMMARY OF THE INVENTION

In view of the aforementioned shortcomings of the conventional nail gel solidification apparatus, the inventor of the present invention based on years of experience in the related industry to conduct extensive researches and experiments, and finally developed a nail gel solidification apparatus, in hope of achieving the effects of providing an application for hands and feet, shortening the solidification time, and lowering the cost.

To achieve the foregoing objectives, the present invention provides a nail gel solidification apparatus, comprising: a housing, substantially in an arc shape, and having an upper casing and a lower casing; a control circuit board, installed in the housing; a plurality of reflecting lamp holders, installed at a lower edge of the control circuit board; a plurality of light emitting diode (LED) elements, installed in the reflecting lamp holders and electrically coupled to the control circuit board; and a power supply module, electrically coupled to the control circuit board; wherein the lower casing includes a plurality of through holes corresponding to the reflecting lamp holders and the LED elements.

Therefore, the nail gel solidification apparatus of the present invention definitely can achieve the effects of providing an application for hands and feet, shortening the solidification time, and lowering the cost.

### BRIEF DESCRIPTION OF THE DRAWINGS

FIG. 1 is a perspective view of a conventional nail gel solidification apparatus;

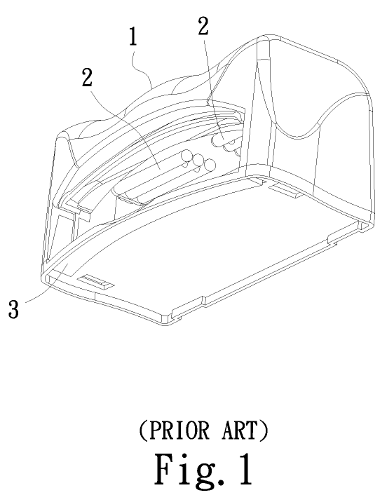

FIG. 2 is an exploded view of a nail gel solidification apparatus in accordance with a preferred embodiment of the present invention;

FIG. 3 is a perspective view of a nail gel solidification apparatus in accordance with a preferred embodiment of the present invention;

FIG. 4 is a schematic view of an external power supply interface of a nail gel solidification apparatus in accordance with a preferred embodiment of the present invention; and

FIGS. 5A and 5B are schematic views of motions of a height adjusting element of a nail gel solidification apparatus in accordance with a preferred embodiment of the present invention.

### DESCRIPTION OF THE PREFERRED EMBODIMENTS

Other features and advantages of the present invention will become apparent in the following detailed description of the preferred embodiments with reference to the accompanying drawings.

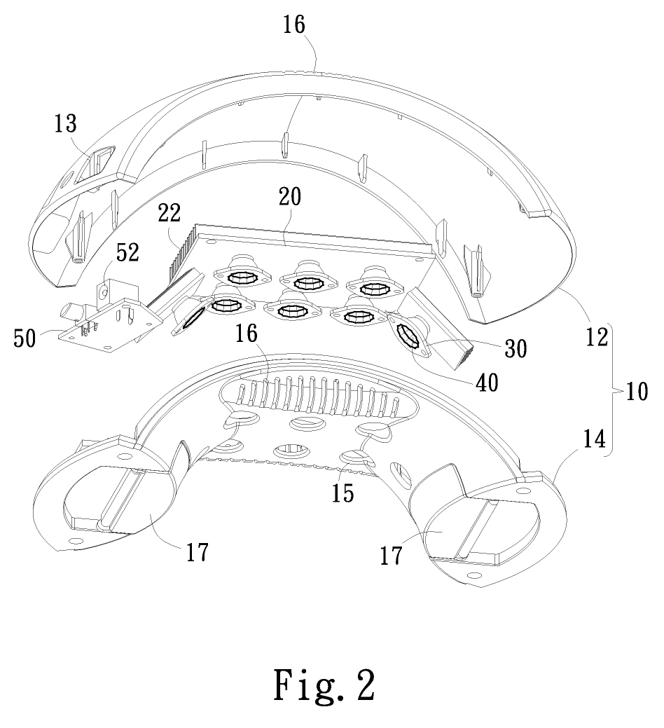

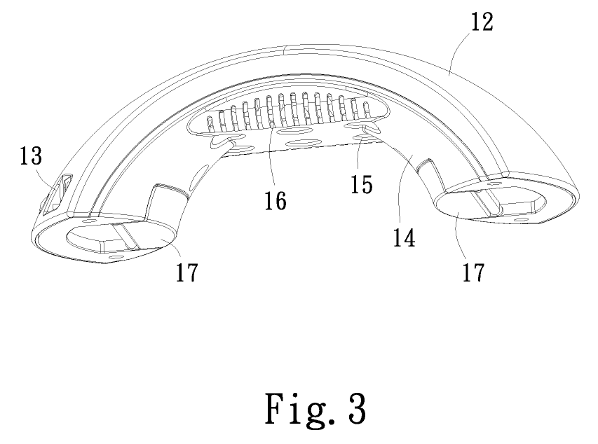

With reference to FIGS. 2 and 3 for an exploded view and a perspective view of a nail gel solidification apparatus in accordance with a preferred embodiment of the present invention respectively, the nail gel solidification apparatus comprises a housing 10, a control circuit board 20, a plurality of reflecting lamp holders 30, a plurality of LED elements 40 and a power supply module 50.

The housing 10 is substantially in an arc shape, and includes an upper casing 12 and a lower casing 14, and the upper casing 12 and/or the lower casing 14 includes a plurality of heat dissipating holes 16, and the lower casing 14 includes a plurality of through holes 15 corresponding to the reflecting lamp holders 30 and the LED elements 40.

The control circuit board 20 is installed in the housing 10, and the control circuit board 20 includes a heat sink 22 installed at an upper edge of the control circuit board 20.

With the heat dissipating holes 16 and the heat sink 22, the heat of a concentrated heat source can be dissipated easily to enhance the using life of each electronic component of the nail gel solidification apparatus.

The reflecting lamp holders 30 are installed at a lower edge of the control circuit board 20, and the reflecting lamp holders 30 include a plurality of LED elements 40 electrically connected to the control circuit board 20.

The conventional lamps are replaced by the LED elements 40, not only reducing power consumption, but also enhancing the light source and the using life of components. In addition, the reflecting lamp holders 30 are provided for concentrating the light source of the LED elements 40 as well as shortening the solidification time of the nail gel effectively.

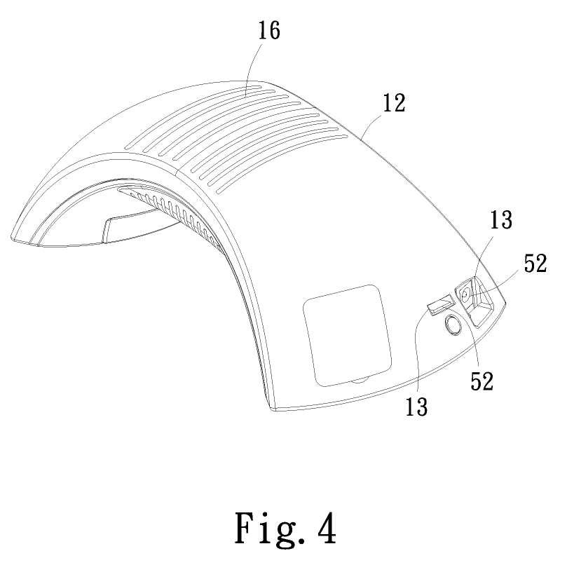

The power supply module 50 supplies a power source by means of an internal power source such as a battery, and the power supply module 50 is electrically connected to the control circuit board 20 for supplying electric power to the control circuit board 20 to control the LED elements 40. The power supply module 50 can include at least one external power supply interface 52 as shown in FIG. 4. The external power supply interface 52 is a USB power supply interface and/or an utility power interface, and thus the upper casing 12 further includes at least one external power supply slot 13 disposed at a position corresponding to the external power supply interface 52, such that the external power source can be connected to the external power supply interface 52.

Therefore, the nail gel solidification apparatus of the invention not only provides a convenient way of carrying the apparatus, but also supplies sufficient electric power by the external power supply.

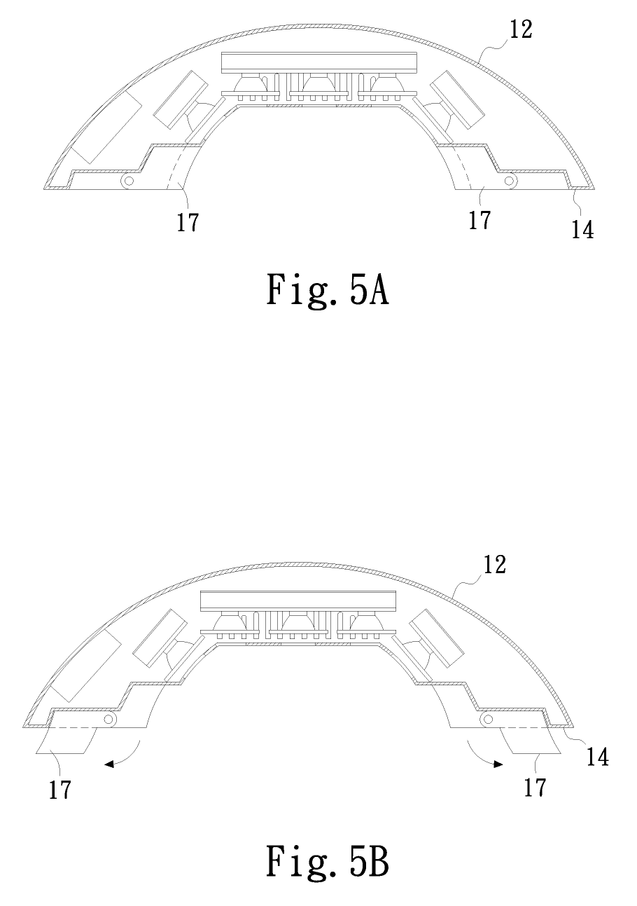

With reference to FIGS. 5A and 5B for schematic views of motions of a height adjusting element of a nail gel solidification apparatus in accordance with a preferred embodiment of the present invention respectively, the lower casing 14 of the nail gel solidification apparatus includes a height adjusting element 17 disposed on both ends of the lower casing 14 and pivotally coupled to the lower casing 14.

Since the housing 10 is in an arc shape, therefore there is no issue of remained sweats, and the nail gel solidification apparatus can be applicable to both hands and feet. With the height adjusting element 17, the nail gel solidification apparatus can be adjusted to fit different users' physical features, and thus there is no issue of a too-close or too-far light source.

In summation of the present invention, the invention adopts the design of the light emitting diode elements, the height adjusting element, the heat dissipating holes and the heat sink of the reflecting lamp holders to achieve the effects of providing applications for both hands and feet, shortening the solidification time, and lowering the cost. Obviously, the present invention complies with the patent application requirements and the products produced according to the present invention can meet the current market requirements.

While the invention has been described by means of specific embodiments, numerous modifications and variations could be made thereto by those skilled in the art without departing from the scope and spirit of the invention set forth in the claims.

What is claimed is:

1. A nail gel solidification apparatus, comprising:
a housing, substantially in an arc shape, and having an upper casing and a lower casing;
a control circuit board, installed in the housing;
a plurality of reflecting lamp holders, installed at a lower edge of the control circuit board;
a plurality of light emitting diode (LED) elements, installed in the reflecting lamp holders and electrically coupled to the control circuit board; and
a power supply module, electrically coupled to the control circuit board;
wherein the lower casing includes a plurality of through holes corresponding to the reflecting lamp holders and the LED elements.

2. The apparatus of claim 1, wherein the power supply module further comprises at least one external power supply interface and at least one external power supply slot disposed at a position of the upper casing and corresponding to the external power supply interface.

3. The apparatus of claim 2, wherein the external power supply interface is a universal serial bus (USB) power supply interface.

4. The apparatus of claim 2, wherein the external power supply interface is a utility power interface.

5. The apparatus of claim 1, wherein the control circuit board includes a heat sink installed at an upper edge of the control circuit board.

6. The apparatus of claim 1, wherein the upper casing and/or the lower casing includes at least one heat dissipating hole.

7. The apparatus of claim 1, wherein the lower casing includes a height adjusting element installed at both ends of the lower casing.

8. The apparatus of claim 7, wherein the height adjusting element is pivotally coupled to the lower casing.
